(19) United States
(12) Patent Application Publication
(10) Pub. No.: US 2010/0287257 A1
(43) Pub. Date: Nov. 11, 2010

(54) RECORDING MEDIUM STORING A RELAY PROGRAM, RELAY APPARATUS, AND RELAY METHOD

(75) Inventors: Kensuke Siozawa, Kawasaki (JP); Yoshitake Shinkai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/774,407

(22) Filed: May 5, 2010

(30) Foreign Application Priority Data
May 8, 2009 (JP) 2009-113144

(51) Int. Cl. G06F 15/16

(52) U.S. Cl. 709/217

(57) ABSTRACT

A relay apparatus includes a first unit to change, in location information referred to using the terminal apparatus in accessing to the single resource and registers an integrated address indicative of the location of the storages as the single resource and addresses indicative of the locations of the storages in correspondence with one another, a first address of the addresses, indicative of the location of a migration source storage that stores migration data to be made to migrate to another storage to a second address indicative of the location of the relay apparatus, a relaying unit to relay access to the migration source storage in response to access to the relay apparatus made from the terminal apparatus based on address changing executed using the first unit, and a migration unit to make the migration data migrate to another storage when the access has been relayed using the relaying unit.

### CROSS-REFERENCE TO RELATED APPLICATIONS

This application is based upon and claims the benefit of priority of the prior Japanese Patent Application No. 2009-113144, filed on May 8, 2009, the entire contents of which are incorporated herein by reference.

### FIELD

The embodiments discussed herein are related to a storage virtualization technique.

### BACKGROUND

Nowadays, a NAS (Network Attached Storage) virtualization technique for bundling up discretely installed NAS systems so as to make a client recognize the NASs so bundled-up as a single virtual NAS is known. In a system configured using the NAS so virtualized, data migration between physical NASs is necessary in order to distribute loads uniformly among the NASs and to manage the life cycle of data stored therein.

Methods of implementing data migration between NASs for the above mentioned requirement are known. As one of these methods, a technique for interposing a relay server through which data migration is performed between NASs over a network channel so as to perform data migration between the NASs while relaying communications between the NASs using the relay server without breaking a request from the client is known (see, for example, Rain Storage, “Rainstorage Architecture—Next Generation NAS Data Migration”, Rainstorage Technical White Paper, Rainfinity, 2003).

According to the above mentioned technique, VLAN setting of a network switch over a network channel is changed to construct two VLANs, one on the side of a client and another on the side of a NAS, so as to interpose a relay server between the client and the NAS. In the case that the VLAN is not used, the relay server is physically interposed between the client and the NAS.

However, the above mentioned technique has such a problem that interposition of the relay server between the client and the NAS over the network channel via the VLAN or physical interposition of the relay server between the client and the NAS over the network channel causes temporary disconnection of the network between the client and the NAS. In addition, such a problem may also generate that the transparency of the system to the client is reduced by disconnection of the network.

### SUMMARY

According to an aspect of the invention (embodiment), a (non-transitory) recording medium storing a relay program that causes a relay apparatus, which relays a communication between a terminal apparatus and a plurality of storages recognized as a single resource by the terminal apparatus, to execute a procedure. The procedure includes a first changing process of changing, in location information which is referred to using the terminal apparatus in accessing to the single resource and registers an integrated address indicative of the location of the plurality of storages as the single resource and addresses indicative of the locations of the plurality of storages in correspondence with one another, a first address of the addresses, indicative of the location of a migration source storage that stores migration data which is to be made to migrate to another storage to a second address indicative of the location of the relay apparatus; a process of relaying access to the migration source storage in response to access to the relay apparatus made from the terminal apparatus based on address changing by executing the first changing process; and a process of making the migration data migrate to another storage in the case that the access has been relayed by executing the access relaying process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a NAS system;

FIG. 2 illustrates an example of apparatuses of the NAS system;

FIG. 3 illustrates an example of a relay apparatus;

FIG. 4 illustrates an example of a registration list;

FIG. 5 illustrates an example of a client (client apparatus);

FIG. 6 illustrates an example of virtually integrated namespaces;

FIG. 7 illustrates an example of a mount map;

FIG. 8 illustrates an example of operations of a relay apparatus involving data migration;

FIG. 9 illustrates an example of operations of a NAS system executed in a relay starting process;

FIG. 10 illustrates an example of a manner of relaying access of a relay apparatus;

FIG. 11 illustrates an example of operations of a relay apparatus executed in a relay starting process;

FIG. 12 illustrates the example of the operations of the relay apparatus executed in the relay starting process;

FIG. 13 illustrates an example of migration data obtained after migration;

FIG. 14 illustrates an example of operations of a NAS system executed in a relay terminating process;

FIG. 15 illustrates an example of operations of a NAS system executed in a relay starting process;

FIG. 16 illustrates an example of operations of a relay apparatus executed in a relay starting process; and

FIG. 17 illustrates an example of a computer system to which the present embodiment is applied.

### DESCRIPTION OF EMBODIMENTS

Next, preferred embodiments will be described with reference to the accompanying drawings.

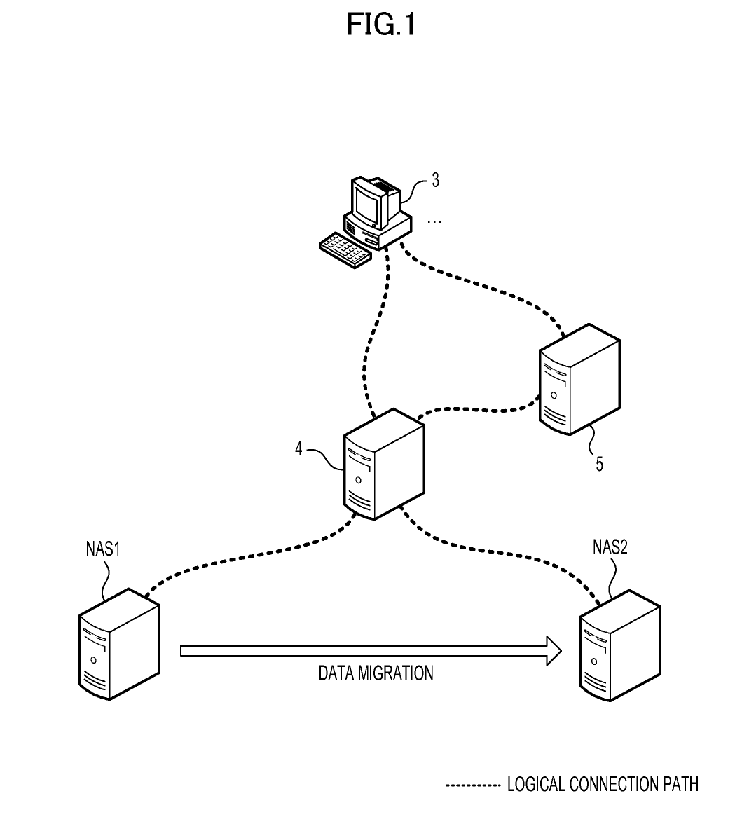

First, a configuration of a NAS system according to the present embodiment will be described. FIG. 1 illustrates an example of a configuration of a NAS system according to the present embodiment. Incidentally, a connection path illustrated in FIG. 1 is a logical one. According to the system of the configuration illustrated in FIG. 1, the permeability of the system in which a plurality of storages is virtually integrated may be increased.

As illustrated in FIG. 1, the NAS system according to the present embodiment includes a NAS 1 (a migration source storage), a NAS 2 (a migration target storage), a client 3 (a terminal apparatus), a relay apparatus 4 and a location managing apparatus 5. The NAS 1 and the NAS 2 are storages which are connected with each other over a network. The client 3 is a terminal which is connected with the NASs 1 and 2 over the network. In the present embodiment, it is assumed that a plurality of clients 3 is present and the NASs 1 and 2 are recognized as a single virtually integrated NAS. The relay apparatus 4 relays communications between the NAS 1 and the client 3 and between the NAS 2 and the client 3 via a network path. The location managing apparatus 5 manages a path in a namespace of NASs which are virtually integrated as a single resource in correspondence with the addresses of the NAS 1 and the NAS 2. In the present embodiment, it is assumed that data is made to migrate from the NAS 1 to the NAS 2.

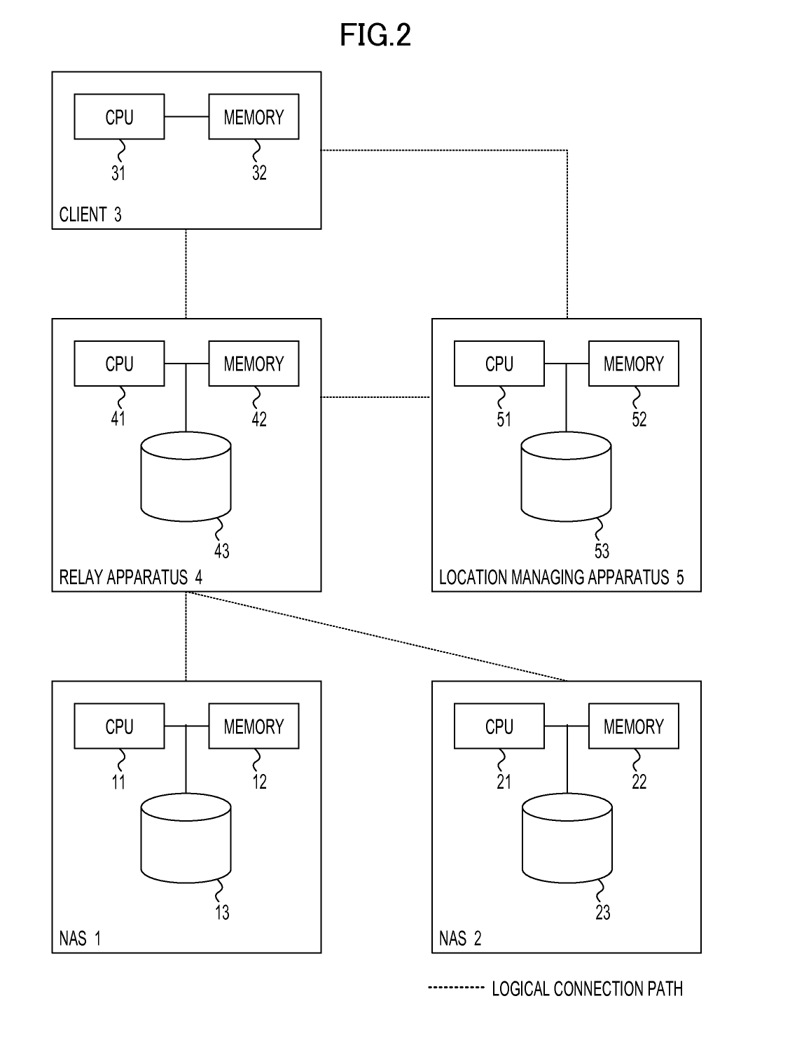

Next, hardware configurations of the apparatuses included in the NAS system according to the present embodiment will be described. FIG. 2 illustrates an example of the hardware configurations of the apparatuses included in the NAS system according to the present embodiment. Incidentally, a connection path illustrated FIG. 2 is a logical one as in the case in the example illustrated in FIG. 1.

As illustrated in FIG. 2, the NAS 1 includes a CPU (Central Processing Unit) 11, a memory 12 and a storage 13. The NAS 2 includes a CPU 21, a memory 22 and a storage 23. The client 3 includes a CPU 31 and a memory 32. The relay apparatus 4 includes a CPU 41, a memory 42 and a storage 43. The location managing apparatus 5 includes a CPU 51, a memory 52 and a storage 53.

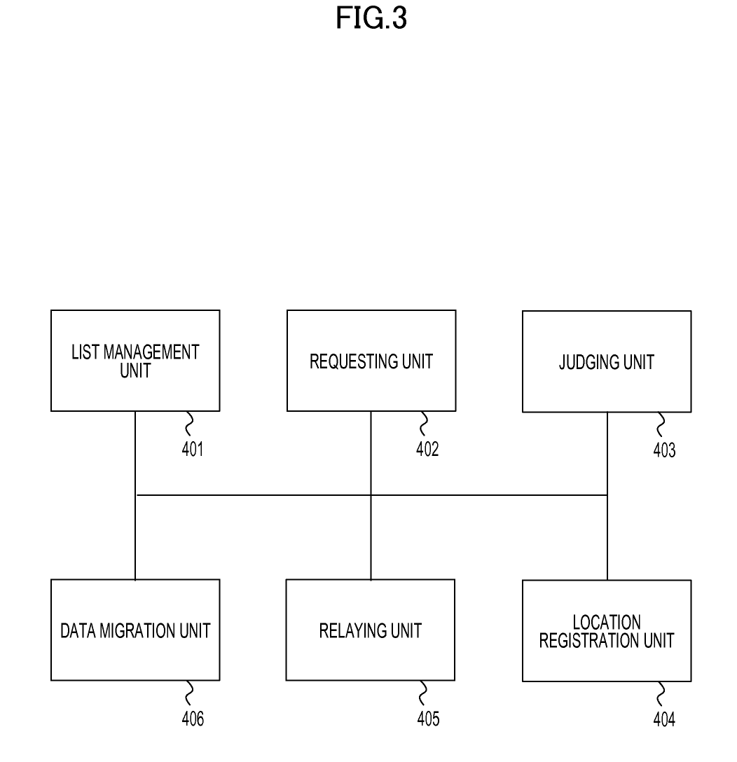

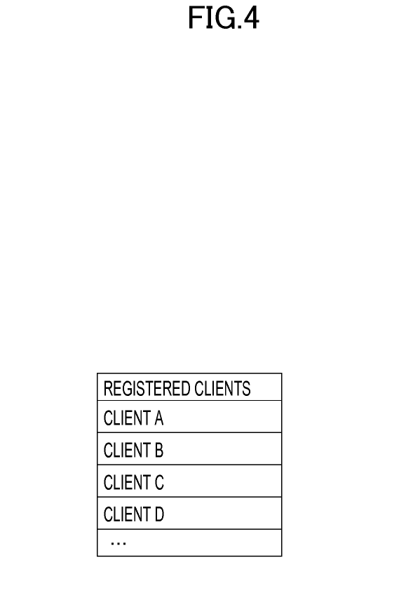

Next, a functional configuration of the relay apparatus according to the present embodiment will be described. FIG. 3 illustrates an example of the functional configuration of the relay apparatus according to the present embodiment. FIG. 4 illustrates an example of a registration list.

As illustrated in FIG. 3, the relay apparatus 4 according to the present embodiment includes a list management unit 401 (a registration unit), a requesting unit 402 (a first requesting unit and a second requesting unit), a judging unit 403, a location registration unit 404 (a first changing unit and a second changing unit), a relaying unit 40 and a data migration unit 406 (a migration unit) as functions. The list management unit 401 manages the registration list illustrated in FIG. 4 and handles requests that data be registered into the registration list and data be deleted from the registration list which are sent from the client 3. The requesting unit 402 requests the client 3 to switch an object to be mounted with reference to a mount map which will be described later. The judging unit 403 executes judgment involving processes executed using the relay apparatus 4. The location registration unit 404 changes the mount map. The relaying unit 405 relays access to migration source data which is made from the client 3. In the case that data migration from one NAS to another NAS has been accepted as a request, the relaying unit 405 records the address of the migration source NAS of the NAS system into the storage 43 of the relay apparatus 4. The data migration unit 406 executes migration of data from one NAS to another NAS. Incidentally, the respective units as described above are functions executed using the CPU 41 of the relay apparatus 4.

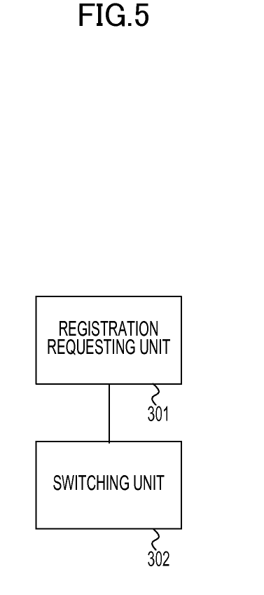

Next, a functional configuration of the client according to the present embodiment will be described. FIG. 5 illustrates an example of the functional configuration of the client according to the present embodiment.

As illustrated in FIG. 5, the client 3 according to the present embodiment includes a registration requesting unit 301 and a switching unit 302 as functions. The registration requesting unit 301 requests the relay apparatus 4 to register the client 3 into the registration list. The switching unit 302 executes switching from direct mounting of the NAS 1 which is the data migration source to mounting via the relay apparatus 4 and switching from the mounting via the relay apparatus 4 to mounting of data which has been made to migrate from one NAS to another NAS. Incidentally, the respective units as described above are functions executed using the CPU 31 of the client 3.

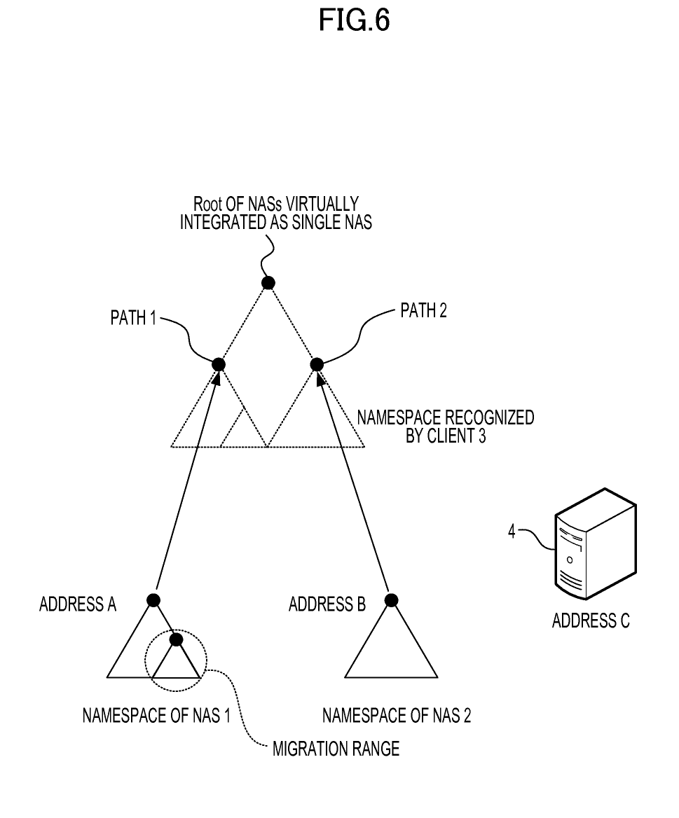

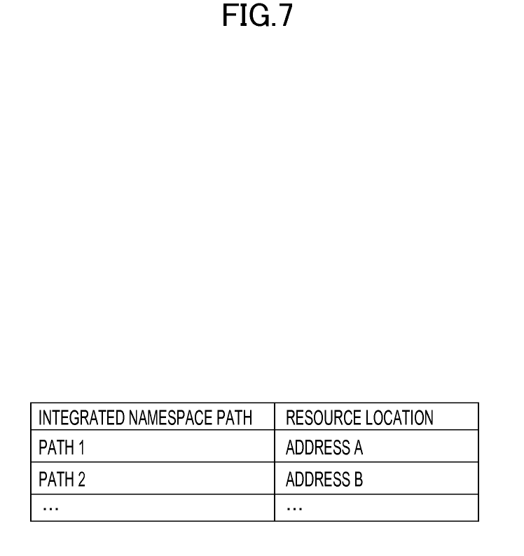

Next, virtual integration in the NAS system will be described. FIG. 6 illustrates an example of a virtually integrated namespace. FIG. 7 illustrates an example of a mount map.

In the NAS system, virtual integration means to make the client 3 virtually recognize a plurality of resources in the NAS system as a single resource. In the present embodiment, the plurality of resources are storage areas in the NAS 1 and the NAS 2. As illustrated in FIG. 6, the namespaces of these storage areas are managed as a virtual namespace of a single resource in the NAS system. In the virtual integration executed in the above mentioned manner, the virtually integrated namespace and the namespaces of the plurality of resources constituting the virtually integrated single resource are recorded in correspondence with one another in accordance with the mount map (location information) stored in the storage 53 of the location managing apparatus 5. As illustrated in FIG. 7, the mount map is information indicating integrated namespace paths (integrated addresses) and resource locations in correspondence with one another. The integrated namespace path is path information indicative of the relative locations of respective resources in the virtually integrated namespace. The resource location is an address which is uniquely allocated to each resource in the NAS system so as to indicate the location of each resource in the NAS system. In the present embodiment, an IP address is used as the address indicative of the location of each resource. Incidentally, in the NAS system according to the present embodiment, it is assumed that the location of the NAS 1 is indicated as an address A (a first address), the location of the NAS 2 is indicated as an address B and the location of the relay apparatus 4 is indicated as an address C (a second address). In the present embodiment, it is also assumed that the relative path of the namespace of the NAS 1 and the relative path of the namespace of the NAS 2 are recorded to respectively correspond to a path 1 and a path 2 relative to the root of the namespaces of the NASs which are virtually integrated as the single NAS. The mount map may be stored, for example, in the storage 43 of the relay apparatus 4, in addition to the storage 53 of the location managing apparatus 5.

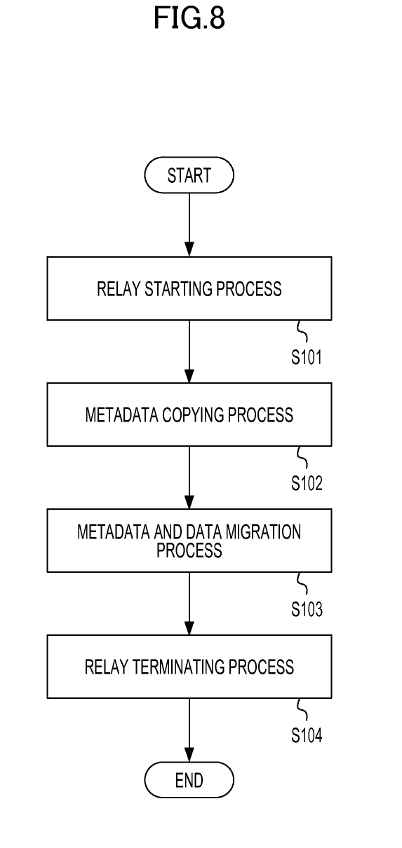

Next, the operation of the relay apparatus in migration of data from one NAS to another NAS will be described. FIG. 8 illustrates an example of the operations of the relay apparatus involving data migration.

In the case that the relay apparatus 4 accepts a request that migration of data from one NAS to another NAS be executed, the relay apparatus 4 executes a relay starting process (step S101) as illustrated in FIG. 8. The relay starting process is a process of relaying access to the NAS 1 as the data migration source. Details of the relay starting process will be described later.

When relaying is started by executing the relay starting process, the relay apparatus 4 executes a metadata copying process (S102, migration step). Here, the metadata copying process will be described. In the metadata copying process, the data migration unit 406 scans a directory tree as a migration range (a range of data which is made to migrate) in the NAS 1 as the data migration source and copies metadata in the range stored in the storage 13 of the NAS 1 and stores the copied metadata into the storage 43 of the relay apparatus 4. Incidentally, in the example illustrated in the drawing, the metadata indicates namespace information and file attribute information. In the case that access is made to the migration data while the metadata copying process is being executed, the data migration unit 406 updates the metadata in the migration range stored in the storage 43 of the relay apparatus 4 so as to continuously retain the metadata in the storage 13 of the NAS 1 in synchronization with the metadata in the storage 43 of the relay apparatus 4.

When execution of the metadata copying process is completed, the relay apparatus 4 executes a metadata and data migration process (S103, migration step). Next, the metadata and data migration process will be described. In the metadata and data migration process, the data migration unit 406 copies the metadata which has been copied and stored into the storage 43 of the relay apparatus 4 and stores the copied data into the storage 23 of the NAS 2 as the data migration destination. The metadata which has been copied and stored into the storage 23 of the NAS 2 is updated in the case that access is made to the data in the migration range so as to be retained in synchronization with the metadata stored in the storages of the NAS 1 and the relay apparatus 4 as in the case with the metadata stored in the storage 43 of the relay apparatus 4. Next, the data migration unit 406 copies migration data whose namespace information and file attribute information are indicated by the metadata which is retained in synchronization with other pieces of metadata and stores the copied data into the NAS 2. In the case that access has been made to the data in the migration range while the migration data is being copied, three pieces of data stored in the NAS 1, the NAS 2 and the relay apparatus 4 are continuously retained in synchronization with one another by reflecting the access on the data in the storages 13, 23 and 43 of the NAS 1, the NAS 2 and the relay apparatus 4.

When execution of the metadata and data migration process is completed, the relay apparatus 4 executes a relay terminating process (S104). The relay terminating process is a process of terminating execution of the relaying operation which has been started by execution of the relay starting process and details thereof will be described later. In the following description, each stage of the relay starting process, the metadata copying process, the metadata and data migration process and the relay terminating process in general processing involving data migration will be referred to as a “general phase” and each processing stage in the general phase will be referred to as a “processing phase”.

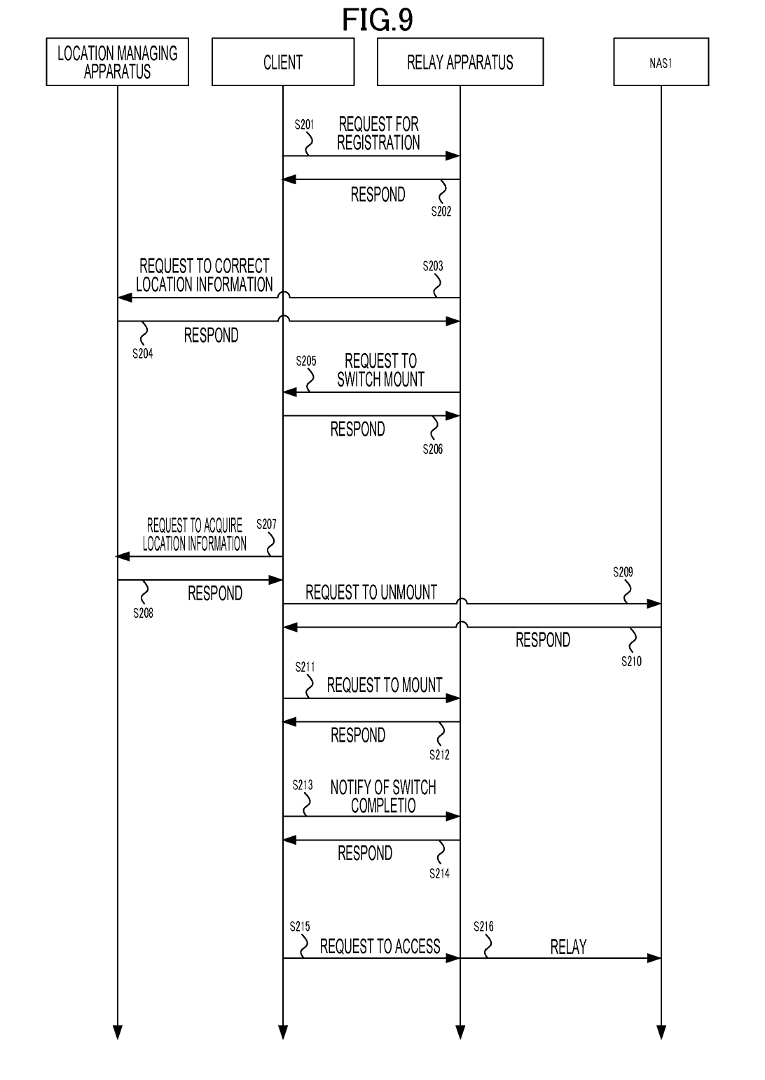

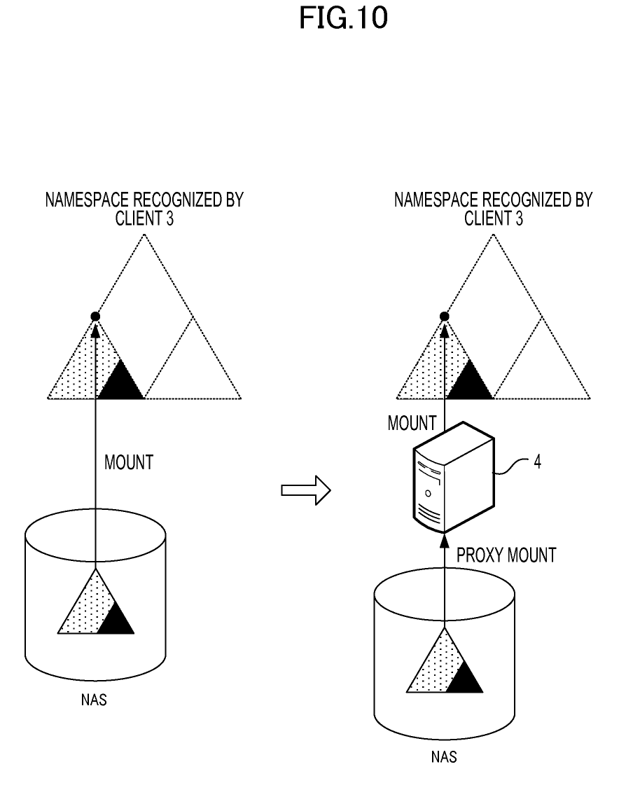

Next, the operations of the NASA system executed in the relay starting process will be described. FIG. 9 illustrates an example of the operations of the NAS system in the relay staring process. FIG. 10 illustrates an example of a manner of relaying access using the relay apparatus. In the example illustrated in FIG. 9, it is assumed that the client 3 has already mounted the NAS 1. It is also assumed that the relay apparatus 4 has already mounted the NAS 1 and the NAS 2.

As illustrated in FIG. 9, first, the registration requesting unit 301 of the client 3 sends the relay apparatus 4 a request that the client 3 be registered (S201, registration requesting step). The list management unit 401 registers the client 3 into the registration list illustrated in FIG. 4 in response to the request and returns a response to the client 3 (S202, registration step).

Next, the location registration unit 404 sends the location managing apparatus 5 a request that the address of the resource location corresponding to the path 1 which is registered in correspondence with the NAS 1 in the virtually integrated namespace be corrected (changed) from the address A to the address C (S203, first changing step). The location managing apparatus 5 changes the address of the resource location corresponding to the path 1 from the address A to the address C in response to the request and returns a response to the client 3 (S204, first changing step).

Next, the requesting unit 402 of the relay apparatus 4 sends the client 3 which is registered in the registration list a request that the amount map be referred to in order to switch the object to be mounted (S205, first requesting step). The switching unit 302 of the client 3 returns a response to the request (S206) and sends the location managing apparatus 5 a request that the client map be acquired (S207, first location information referring step). The location managing apparatus 5 returns the mount map as the response to the request (S208, first location information referring step). The client 3 refers to the mount map which has been returned as the response.

In the mount map that the client 3 refers to, the path 1 is registered in correspondence with the address C as described above, so that the switching unit 302 of the client 3 sends the NAS 1 indicated by the address A a request that the NAS 1 be unmounted from the client 3 (S209). The switching unit 302 receives a response to this request to unmount the NAS 1 from the client 3 (S210). After the NAS 1 has been unmounted, the switching unit 302 sends the relay apparatus 4 a request that the relay apparatus 4 be mounted on the client 3 (S211, accessing step) and receives a response to this request to mount the relay apparatus 4 (S212, accessing step). After unmounting of the NAS 1 and mounting of the relay apparatus 4 have been completed, the switching unit 302 sends the relay apparatus 4 a notification that switching has been completed (S213) and the requesting unit 402 returns a response to the notification (S214).

After switching of the object to be mounted has been executed using the switching unit 302, the client 3 sends the relay apparatus 3 a request that access be gained to data in the range indicated by the path 1 in the virtually integrated namespace (S215, relaying step). Then, the relaying unit 405 relays access to the NAS 1 in response to the request for access to the data (S216, relaying step). The relay apparatus 3 executes as proxy mounting of the NAS 1 to relay the access to the NAS 1 in the manner as illustrated in FIG. 10. The NAS whose mounting is executed using the relay apparatus 3 as proxy is the one indicated by the address which has been stored in the storage 43 using the relaying unit 405.

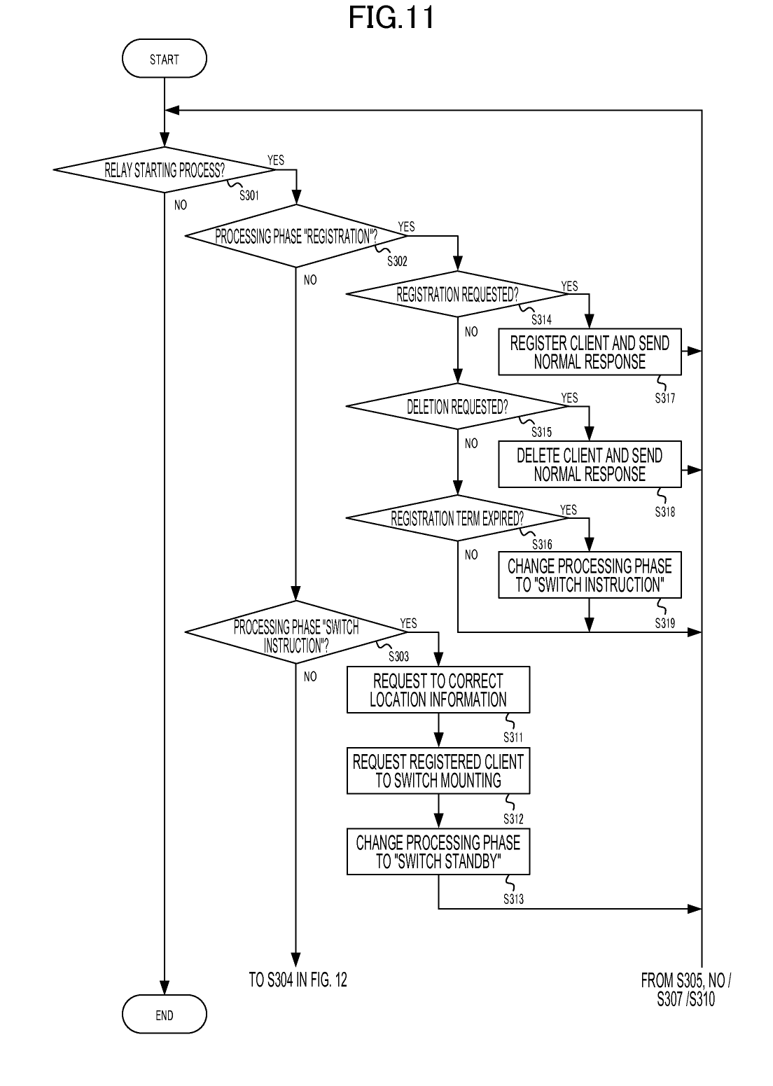

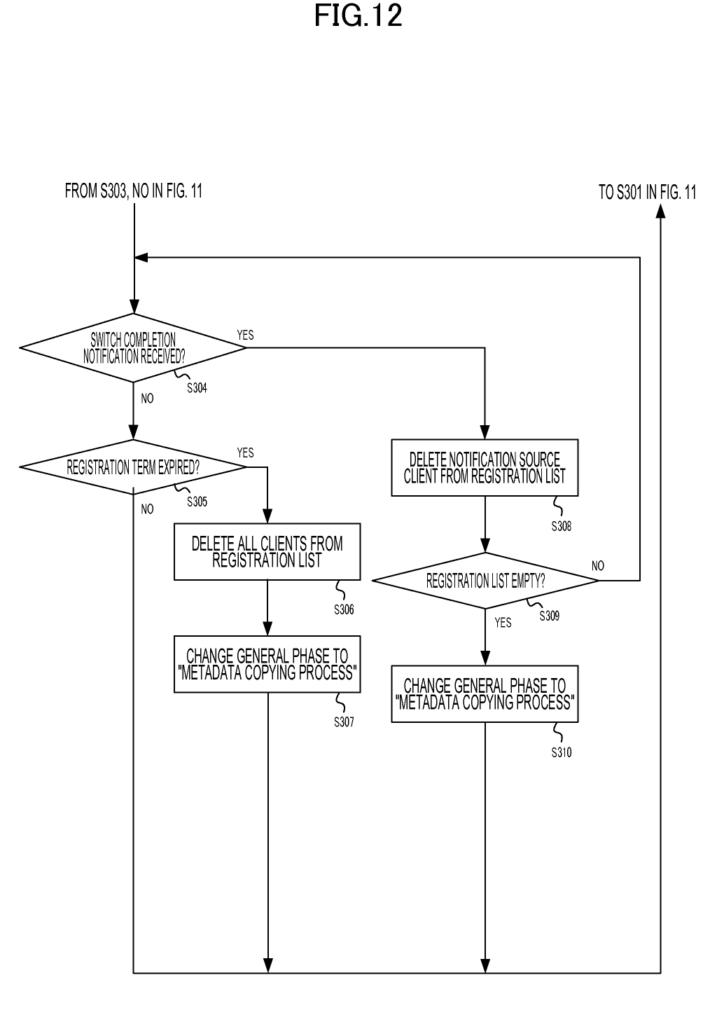

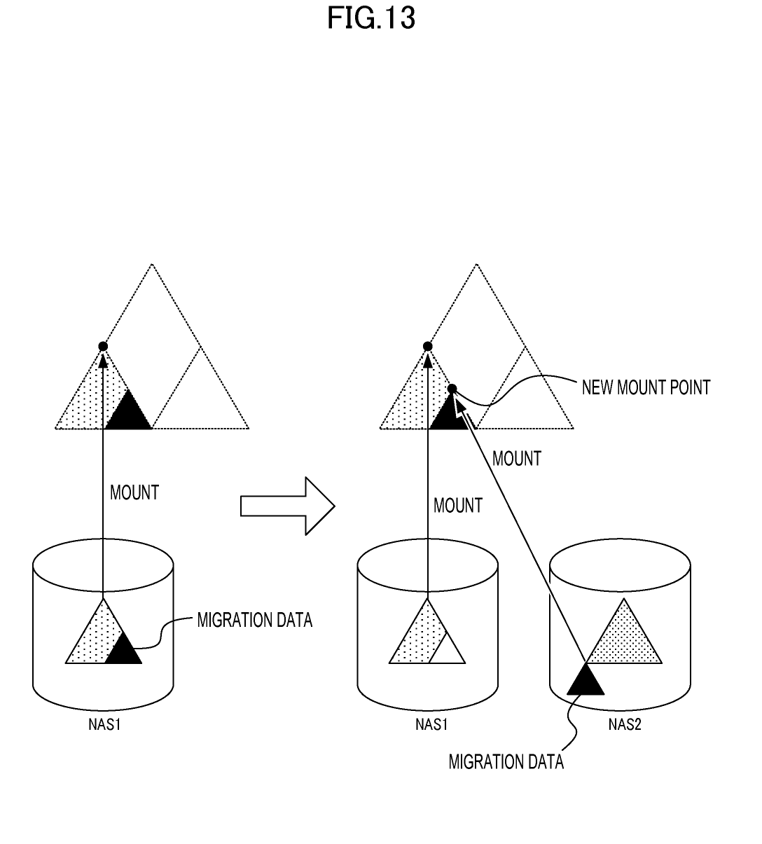

Next, a switching process to be executed in the relay starting process will be described. The switching process is executed in order to switch mounting of the NAS as the migration source on the client to mounting of the relay apparatus on the client for the purpose of starting relaying of access to the NAS concerned and corresponds to steps S201 to S206 and S214. FIGS. 11 and 12 illustrate an example of the operations of the relay apparatus executed in the relay starting process. FIG. 13 illustrates an example of migration data obtained after migration has been executed.

As illustrated in FIG. 11, first, the judging unit 403 judges whether the general phase is the “relay starting process” (S301).

In the case that the general phase is not the “relay starting process” (S301, NO), the process is terminated.

On the other hand, in the case that the general phase is the “relay starting process” (S301, YES), the judging unit 403 judges whether the processing phase is “registration” (S302).

In the case that the processing phase is not the “registration” (S302, NO), the judging unit 403 judges whether the processing phase is “switch instruction” (S303).

In the case that the processing phase is not the “switch instruction” (S303, NO), the judging unit 403 judges whether a switch completion notification (a notification that switching has been completed) has been received from the client 3 (S304).

In the case that the switch completion notification is not received from the client 3 (S304, NO), the judging unit 403 judges whether a registration term has expired (S305). The registration term is a term which has been determined in advance as a term within which a request that the client 3 be registered into the registration list is accepted.

In the case that the registration term does not expire (S305, NO), the judging unit 403 judges again whether the general phase is the “relay staring process” (S301).

On the other hand, in the case that the registration term has expired (S305, YES), the list management unit 401 deletes all the clients registered in the registration list (S306) and changes the general phase to the “metadata copying process” (S307). Then, after the general phase has been changed to the “metadata copying process”, the judging unit 403 judges again whether the general phase is the “relay starting process” (S301).

In the case that it has been judged at step S304 that the switch completion notification has been received from the client 3 (S304, YES), the list management unit 401 deletes the client 3 as the notification source from which the switch completion notification has been sent from the registration list (S308). Next, the list management unit 401 checks to see whether the registration list is empty (S309).

In the case that the registration list is empty (S309, YES), the list registration unit 401 changes the general phase to the “metadata copying process” (S310). Then, after the general phase has been changed to the “metadata copying process”, the judging unit 403 judges again whether the entire phase is the “relay starting process” (S301).

On the other hand, in the case that the registration list is not empty (S309, NO), the judging unit 403 judges again whether the switch completion notification has been received from the client 3 (S304).

It has been judged at step S303 that the processing phase is the “switch instruction” (S303, YES), the location registration unit 404 requests the location managing apparatus 5 to correct the mount map (S311, first changing step). Specifically, the location registration unit 404 sends the location managing apparatus 5 a request that the mount map be corrected by recording the virtually integrated namespace path which is set in correspondence with the resource location of the data migration source and the resource location of the relay apparatus 4 in correspondence with each other. That is, the location registration unit 404 changes the resource location of the data migration source to the resource location of the relay apparatus 4.

Next, the requesting unit 402 sends the client 3 which is registered in the registration list a request that mounting be changed (S312) and changes the processing phase to “switch standby” (S313). Then, after the processing phase has been changed to the “switch standby”, the judging unit judges again whether the general phase is the “relay starting process” (S301).

In the case that it has been judged at step S302 that the processing phase is the “registration” (S302, YES), the judging unit 403 judges whether a request that the client 3 be registered into the registration list is sent from the client 3 (S314).

In the case that the request that the client 3 be registered into the registration list is not sent from the client 3 (S314, NO), the judging unit 403 judges whether a request that the client 3 be deleted from the registration list is sent from the client 3 (S315).

In the case the request that the client 3 be deleted from the registration list is not sent from the client 3 (S315, NO), the judging unit 403 judges whether the registration term has expired (S316).

In the case that the registration term does not expire (S316, NO), the judging unit judges again whether the general phase is the “relay starting process” (S301).

On the other hand, in the case that the registration term has expired (S316, YES), the list management unit 401 changes the processing phase to the “switch instruction” (S319). Then, after the processing phase has been changed to the “switch instruction”, the judging unit 403 judges again whether the general phase is the “relay starting process” (S301).

In the case that it has been judged at step S314 that the request that the client 3 be deleted from the registration list is sent from the client 3 (S315, YES), the list management unit 401 deletes the client as the request source (from which the request has been sent) from the registration list and returns a normal response (a response that the request has been normally processed) to the client in response to the request (S318). Next, after the response has been returned to the client 3, the judging unit 403 judges again whether the general phase is the “relay starting process” (S301).

In the case that it has been judged at step S313 that the request that the client 3 be registered into the registration list is sent from the client 3 (S314, YES), the list management unit 401 registers the client 3 as the request source into the registration list and returns the normal response to the client 3 in response to the request (S317, registration step). Next, after the response has been returned to the client 3, the judging unit 403 judges again whether the general phase is the “relay starting process” (S301).

As described above, the relay apparatus 4 according to the present embodiment manages the clients 3 in the NAS system in accordance with the registration list and makes the client 3 in the registration list switch the object to be mounted from the data migration source to the relay apparatus 4. The above mentioned operation makes it possible to start relaying of access to the data migration source while maintaining the permeability of the NAS system to the users of all the clients 3 in the NAS system.

In addition, after the relaying operation has been started, data migration is executed without changing the location in the virtually integrated namespace as illustrated in FIG. 13. In the case that the client 3 gains access to the migration data, although the virtually integrated namespace thereof is the same as that obtained before migration, the NAS 2 that retains the migration data is mounted upon accessing to the migration data.

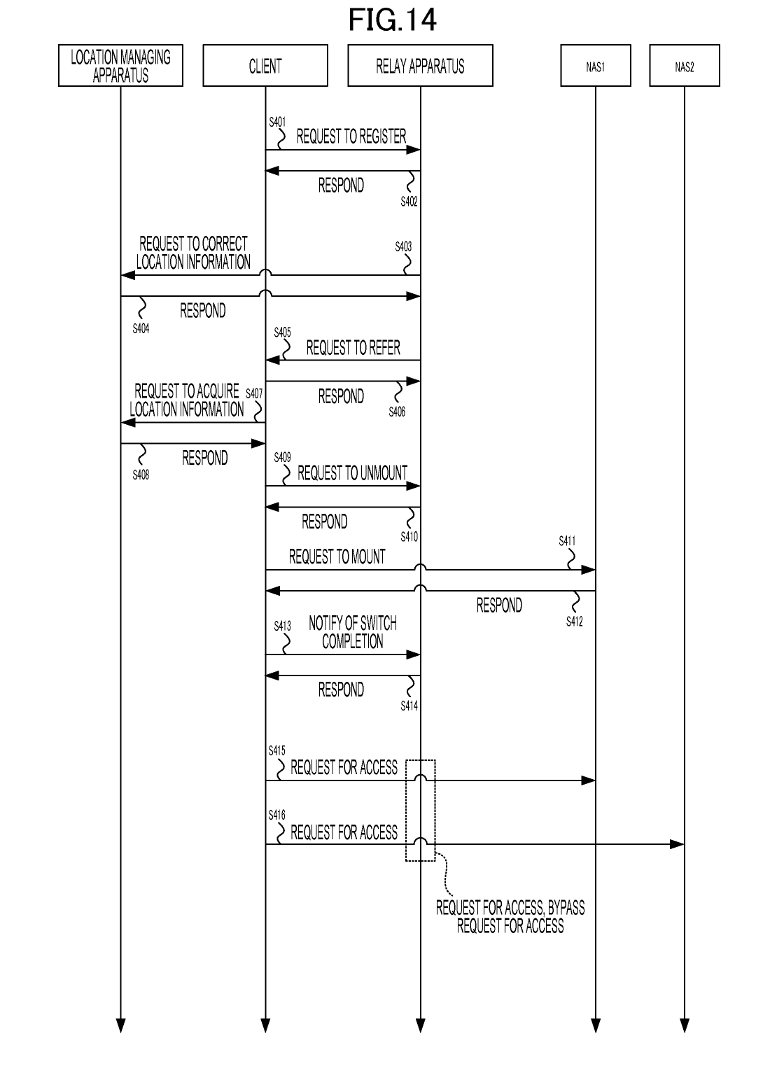

Management of the clients 3 in accordance with the registration list may be applied not only when the relaying operation is started by also when the relaying operation is terminated. Specifically, a client 3 that mounts the relay apparatus 4 is added to the registration list so as to make the client 3 in the registration list switch the object to be mounted from the relay apparatus 4 to the data migration source. Next, the operations of the NAS system executed in a relay terminating process will be described. FIG. 14 illustrates an example of the operations of the NAS system executed in the relay terminating process.

First, the registration requesting unit 301 of the client 3 sends the relay apparatus 4 a request that the client 3 be registered into the registration list (S401, registration requesting step) as illustrated in FIG. 14. The list management unit 401 registers the client 3 into the registration list illustrated in FIG. 4 in response to the request and returns a response to the client 3 (S402, registration step).

Next, the location registration unit 404 of the relay apparatus 4 sends the location managing apparatus 5 a request that the address of the resource location corresponding to the path 1 which is set in correspondence with the relay apparatus 4 in the virtually integrated namespace be corrected from the address C to the address A (S403, second changing step). The location managing apparatus 5 changes the address of the resource location corresponding to the path 1 from the address C to the address A in response to the request and returns a response to the relay apparatus 4 (S404, second changing step). That is, the location managing apparatus 5 changes the resource location of the relay apparatus 4 to the resource location of the data migration source.

Next, the requesting unit 402 of the relay apparatus 4 sends the client 3 which is registered in the registration list a request that the mount map be referred to (S405, second requesting step). The switching unit 302 of the client 3 returns a response to the request (S406) and sends the location managing apparatus 5 a request that the mount map be acquired (S407, second location information referring step). The location managing apparatus 5 returns the mount map to the client 3 as the response to the request (S408, second location information referring step). The client 3 refers to the mount map which has been returned as the response to the request.

In the mount map that the client 3 refers to, the path 1 is registered in correspondence with the address A, so that the switching unit 302 of the client 3 sends the relay apparatus 4 a request that the relay apparatus 4 be unmounted from the client 3 (S409). The switching unit 302 obtains a response to the request and unmounts the relay apparatus 4 (S410). After the relay apparatus 4 has been unmounted, the switching unit 302 sends the NAS 1 a request that the NAS 1 be mounted on the client 3 (S411), and obtains a response to the request and mounts the NAS 1 (S412). After unmounting of the relay apparatus and mounting of the NAS 1 have been completed, the switching unit 302 sends the relay apparatus 4 a notification that switching has been completed (S413) and the requesting unit 402 returns a response to the notification (S414).

After switching of the object to be mounted has been completed using the switching unit 302, the client 3 requests to access to the data in the virtually integrated namespace (S415, S416). Then, the relaying unit 405 bypasses the access to the NAS 1. That is, the relaying unit 405 stops relaying of the access to the NAS 1.

As described above, the relay apparatus 4 according to the present embodiment manages the client 3 in the NAS system on the basis of the registration list and makes the client 3 in the registration list change the object to be mounted from the relay apparatus 4 to the data migration source. This operation makes is possible to terminate relaying of the access to the migration data while maintaining the permeability of the NAS system to the users of all the clients 3 in the NAS system.

Incidentally, the operations of the relay apparatus 4 executed in the relay terminating process are almost the same as those executed in the relay starting process except the following points. Specifically, the relay terminating process differs from the relay starting process in that as the operation corresponding to step S301, it is judged whether the general phase is the “relay terminating process”, in place of judgment on the “relay starting process”. In addition, as the operation corresponding to step S307, the relaying unit 405 stops relaying of the access to the NAS. Further, the operation which is executed for correction of the mount map and corresponds to the step S309 is different from that in the relay starting process. The location registration unit 404 sends the location managing apparatus 5 the request that the mount map be corrected by recording the virtually integrated namespace path which is set in correspondence with the resource location of the relay apparatus 4 and the resource location of the data migration source in correspondence with each other.

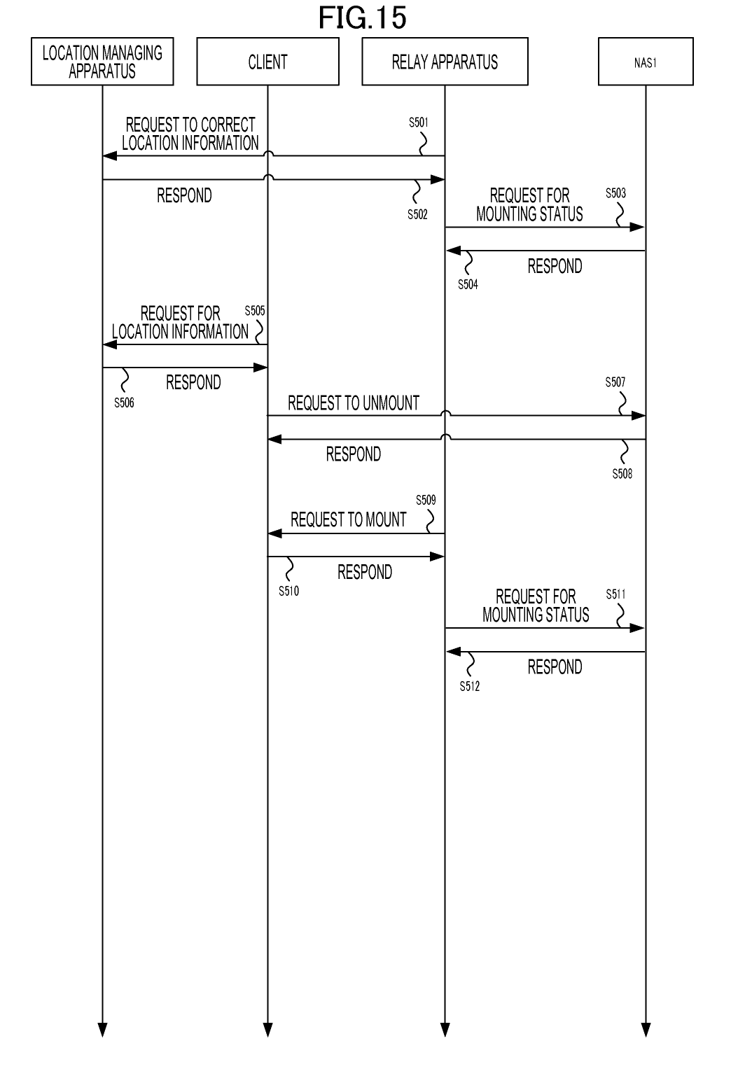

The present embodiment differs from the embodiment described above in that an inquiry about a mounting status is sent to the data migration source, instead of registration of the client 3 into the registration list. The relay apparatus 4 according to the present embodiment differs from the relay apparatus according to the embodiment described above in that the list management unit 401 is not included therein as the function because of the above mentioned difference. First, the operations of the NAS system executed in the relay starting process according to the present embodiment will be described. FIG. 15 illustrates an example of the operations of the NAS system executed in the relay starting process according to the present embodiment.

As illustrated in FIG. 15, the location registration unit 404 of the relay apparatus 4 sends the location managing apparatus 5 a request that the address of the resource location corresponding to the path 1 which is set in correspondence with the NAS 1 in the virtually integrated namespace be corrected from the address A to the address C (S501). The location managing apparatus 5 changes the address of the resource location corresponding to the path 1 from the address A to the address C in response to the request and returns a response to the relay apparatus 4 (S502).

Next, the requesting unit 402 of the relay apparatus 4 sends the NAS 1 a request that the mounting status be notified (S503, acquiring step). Specifically, the requiring unit 402 requests the NAS 1 to acquire a list of clients which are now mounting the NAS 1 (the mount list). The NAS 1 sends the relay apparatus 4 the mount list as the response to the request (S504). That is, the requiring unit 402 acquires the mount list from the NAS 1.

Next, the switching unit 302 of the client 3 sends the location managing apparatus 5 a request that the mount list be acquired (S505). The location managing apparatus 5 sends the client 3 the mount list as the response to the request (S506).

In the amount map which has been sent to the client 3 as the response, the path 1 is registered in correspondence with the address C, so that the switching unit 302 of the client 3 sends the NAS 1 a request that the NAS 1 be unmounted from the client 3 (S507). Then, the switching unit 302 obtains a response to the request and unmounts the NAS 1 (S508). After the NAS 1 has been unmounted, the switching unit 302 sends the relay apparatus 4 a request that the relay apparatus 4 be mounted on the client (S509), and obtains a response to the request and mounts the relay apparatus 4 (S510).

Next, the requesting unit 402 of the relay apparatus 4 again sends the NAS 1 the request that the mounting status be notified (S511). The NAS 1 sends the relay apparatus 4 the mount list as the response to the request (S512).

The relay apparatus 4 according to the present embodiment confirms the mounting status of the client 3 by inquiring the NAS 1 as the data migration source about the mounting status in the above mentioned manner. Thus, according to the present embodiment, the client 3 need not send the relay apparatus 4 a request that the client 3 be registered into the registration list in the relay apparatus.

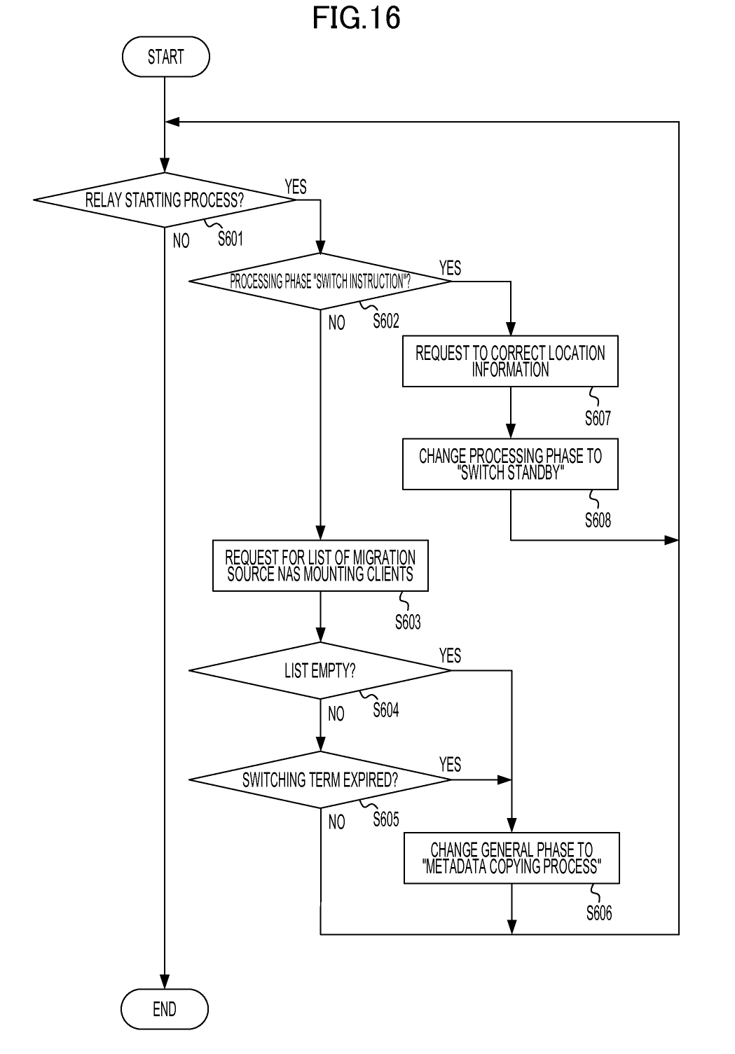

Next, the operations of the relay apparatus according to the present embodiment will be described. FIG. 16 is a diagram illustrating an example of the operations of the relay apparatus executed in the relay starting process according to the present embodiment.

As illustrated in FIG. 16, first, the judging unit 403 judges whether the general phase is the “relay starting process” (S601).

In the case that the general phase is not the “relay starting process” (S601, NO), the process is terminated.

On the other hand, in the case that the general phase is the “relay starting process” (S601, YES), the judging unit 403 judges whether the processing phase is the “switch instruction” (S602).

In the case that the processing phase is not the “switch instruction” (S602, NO), the requesting unit 402 sends the NAS which is the data migration source a request that the mount list be sent and acquires the list (S603, acquiring step). Next, the judging unit 403 judges whether the mount list is empty (S604).

In the case that the mount list is not empty (S604, NO), the judging unit 403 judges whether the switching term has expired (S605). The switching term is a term which has been determined in advance as the term for which switching of the object to be mounted on the client 3 is put on standby.

In the case that the switching term does not expire (S605, NO), the judging unit 403 judges again whether the general phase is the “relay starting process” (S601).

On the other hand, in the case that the switching term has expired (S605, YES), the judging unit 403 changes the general phase to the “metadata copying process” (S606) and then judges again whether the general phase is the “relay starting process” (S601).

In the case that it has been judged at step S604 that the mount list is empty (S604, YES), the judging unit 403 changes the general phase to the “metadata copying process” (S606) and then judges again whether the general phase is the “relay starting process” (S601).

In the case that it has been judged at step S602 that the processing phase is the “switch instruction” (S602, YES), the location registration unit 404 sends the location managing apparatus 5 a request that the amount map be corrected (SA607). Specifically, the location registration unit 404 sends the location managing apparatus 5 a request that the mount map be corrected by recording the virtually integrated namespace path which is set in correspondence with the resource location of the data migration source and the resource location of the relay apparatus 4 in correspondence with each other.

Next, the location registration unit 404 changes the processing phase to “switch standby” (S608) and the judging unit 403 judges again whether the general phase is the “relay starting process (S601).

As described above, the relay apparatus 4 according to the present embodiment inquires the NAS which is the data migration source about the status of mounting of the NAS on the clients 3 and keeps switching of the object to be mounted put on standby until the number of clients 3 that mount the NAS is reduced to zero. The above mentioned operation makes it possible to put switching of the objects to be mounted on all the clients 3 on standby with no necessity of registration of the clients 3 into the registration list.

Incidentally, the operations of the relay apparatus 4 executed in the relay terminating process are almost the same as those in the relay staring process except the following points. Specifically, the operation corresponding to step S601 is different from that in the relay staring process in that it is judged whether the general phase is the “relay terminating process”. In addition, the operation corresponding to step SA603 is different from that in the relay staring process in that the requesting unit 402 confirms by itself the client 3 which is now in a mounting state. That is, the requesting unit 402 refers to the mount lists in the relay apparatus 4. Further, the operation corresponding to step S606 is different from that in the relay starting process in that the relaying unit 405 stops the relaying operation (stopping step). Still further, the mount map correcting operation corresponding to step S607 is different from that in the relay starting process. That is, in the relay terminating process, the location registration unit 404 sends the location managing apparatus 5 the request that the mount map be corrected by recording the virtually integrated namespace path which is set in correspondence with the resource location of the relay apparatus 4 and the resource location of the data migration source in correspondence with each other.

The above mentioned operation makes it possible to put stopping of the relaying operation on standby with no necessity of registration of the client 3 into the registration list.

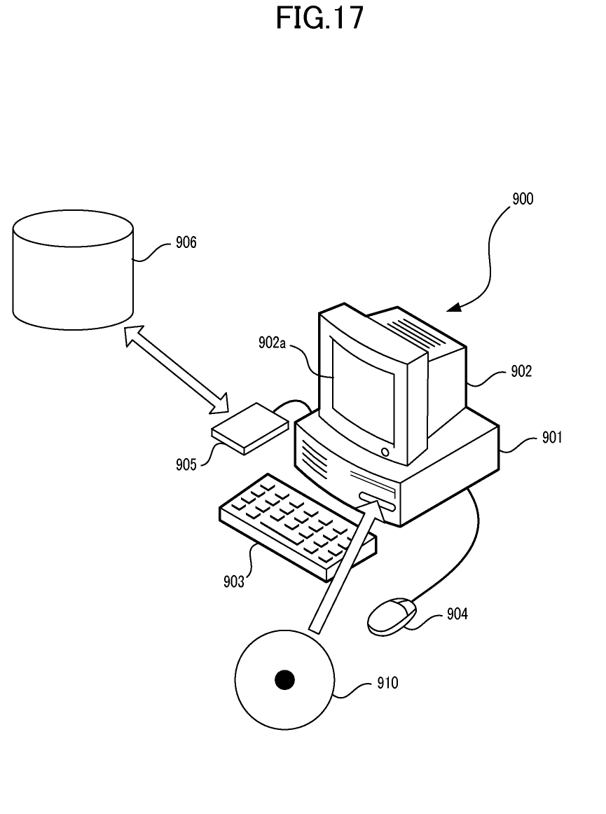

The above mentioned embodiments may be also applicable to a computer system which will be described hereinbelow. FIG. 17 illustrates an example of a computer system. A computer system 900 illustrated in FIG. 17 includes a main body unit 901 into which a CPU, a disk drive and others are built, a display 902 that displays images under the instruction from the main body unit 901, a keyboard 903 through which various pieces of information are input into the computer system 900, a mouse 904 used to specify an arbitrary position on a display screen 902a of the display 902 and a communication apparatus 905 that gains access to an external database and the like to download programs and others stored in another computer system. As the communication apparatus 905, a network communication card, a modem and others may be thought of.

A program in accordance with which the computer system which is configured as the relay apparatus 4 as described above executes the respective steps as described above may be provided as a relay program. It may become possible to make the computer system which is configured as the relay apparatus 4 execute the steps in accordance with the relay program by storing the relay program in a computer system readable recording medium. The program in accordance with which the above mentioned respective steps are executed is stored in a portable recording medium such as a disk 910 or the like or is downloaded from a recording medium 906 of another computer system via the communication apparatus 905. The relay program (relay software) which is programmed such that the computer system 900 has at least a relaying function is input into the computer system 900 to be compiled. The relay program makes the computer system 900 operate as the relay apparatus 4 having the relaying function. As an alternative, the relay program may be stored in a non-transitory computer readable recording medium such as the disk 910. In the above mentioned case, the non-transitory computer readable recording medium out of which the computer system 900 may read data includes internal storage devices which are internally packaged into computers such as ROMs and RAMs, portable storing (recording) media such as the disk 910, flexible disks, DVD disks, magnet-optical disks and IC cards, database machines in which computer programs are held, other computer systems and database machines for use in the systems and various recording media built into other accessible computer systems.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A non-transitory recording medium storing a relay program that causes a relay apparatus, which relays a communication between a terminal apparatus and a plurality of storages recognized as a single resource by the terminal apparatus, to execute a procedure, the procedure comprising:
a first changing process of changing, in location information which is referred to using the terminal apparatus in accessing the single resource and registers an integrated address indicative of a location of the plurality of storages as the single resource and addresses indicative of the locations of the plurality of storages in correspondence with one another, a first address of the addresses, indicative of a location of a migration source storage that stores migration data which is to be made to migrate to another storage to a second address indicative of the location of the relay apparatus;
a process of relaying access to the migration source storage in response to access to the relay apparatus made from the terminal apparatus based on address changing by executing the first changing process; and
a process of making the migration data migrate to another storage when the access has been relayed by executing the access relaying process.

2. The non-transitory recording medium according to claim 1, the procedure further comprising:
a process of further making a computer, when the migration data has been made to migrate to another storage by executing the migration process, execute a second changing process of changing the second address to the first address in the location information.

3. The non-transitory recording medium according to claim 1, the procedure further comprising:
a registering process of registering the terminal apparatus in response to a request that the terminal apparatus be registered into the relay apparatus which is sent from the terminal apparatus; and
a first requesting process of requesting the terminal apparatus which has been registered by executing the registering process to refer to the location information in which the first address has been changed to the second address by executing the first changing process.

4. The non-transitory recording medium according to claim 3, the procedure further comprising:
a second requesting process of requesting the terminal apparatus which has been registered by executing the registering process, when the migration data has been made to migrate to another storage by executing the migration process, to refer to the location information in which the second address has been changed to the first address by executing the second changing process.

5. The non-transitory recording medium according to claim 1, the procedure further comprising:
an acquiring process of acquiring first mount information indicative of whether the terminal apparatus mounts the migration source storage from the migration source storage,
wherein, when the first mount information which has been acquired by executing the acquiring process indicates that the terminal apparatus does not mount the migration source storage, the migration data is made to migrate to another storage by executing the migration process.

6. The non-transitory recording medium according to claim 2, the procedure further comprising:
a referring process of, when the second address has been changed to the first address in the location information by executing the second changing process, referring to second mount information which is registered in the relay apparatus and indicates whether the terminal apparatus mounts the relay apparatus; and
a stopping process of, when the second mount information which has been referred to by executing the referring process indicates that the terminal apparatus does not mount the relay apparatus, stopping relaying of the access which has been relayed by executing the relaying process.

7. A relay apparatus that relays a path of connection between a terminal apparatus and a plurality of storages which are connected with the terminal apparatus via a network and are recognized by the terminal apparatus as an integrated single resource, the relay apparatus comprising:
a first changing unit configured to change, in location information which is referred to using the terminal apparatus in accessing the single resource and registers an integrated address indicative of a location of the plurality of storages as the single resource and addresses indicative of the locations of the plurality of storages in correspondence with one another, a first address of the addresses, indicative of a location of a migration source storage that stores migration data which is to be made to migrate to another storage to a second address indicative of the location of the relay apparatus;
a relaying unit configured to relay access to the migration source storage in response to access to the relay apparatus made from the terminal apparatus based on address changing executed using the first changing unit; and
a migration unit configured to make the migration data migrate to another storage when the access has been relayed using the access relaying unit.

8. The relay apparatus according to claim 7, further comprising:
a second changing unit configured to change, when the migration data has been made to migrate to another storage using the migration unit, the second address to the first address.

9. The relay apparatus according to claim 7, further comprising:
a registering unit configured to register the terminal apparatus in response to a request that the terminal apparatus be registered into the relay apparatus which is sent from the terminal apparatus; and
a first requesting unit configured to request the terminal apparatus which has been registered using the registering unit to refer to the location information in which the first address has been changed to the second address using the first changing unit.

10. The relay apparatus according to claim 9, further comprising:
a second requesting unit configured to request the terminal apparatus which has been registered using the registering unit, when the migration data has been made to migrate to another storage using the migration unit, to refer to the location information in which the second address has been changed to the first address using the second changing unit.

11. The relay apparatus according to claim 7, further comprising:
an acquiring unit configured to acquire first mount information indicative of whether the terminal apparatus mounts the migration source storage from the migration source storage,
wherein, when the first mount information which has been acquired using the acquiring unit indicates that the terminal apparatus does not mount the migration source storage, the migration unit makes the migration data migrate to another storage.

12. The relay apparatus according to claim 8, further comprising
a referring unit configured to refer, when the second address has been changed to the first address in the location information using the second changing unit, to second mount information which is registered in the relay apparatus and indicates whether the terminal apparatus mounts the relay apparatus; and
a stopping unit configured to stop, when the second mount information which has been referred to using the referring unit indicates that the terminal apparatus does not mount the relay apparatus, relaying of the access which has been relayed using the relaying unit.

13. A relay method for use in a system comprising a terminal apparatus, a plurality of storages which are connected with the terminal apparatus over a network and are recognized by the terminal apparatus as an integrated single resource and a relay apparatus that relays a path of connection between the plurality of storages and the terminal apparatus, the method comprising:
a first changing process in which, in location information which registers an integrated address indicative of a location of the plurality of storages as the single resource and addresses indicative of the locations of the plurality of storages in correspondence with one another, the relay apparatus changes a first address of the addresses, indicative of the location of a migration source storage that stores migration data which is to be made to migrate to another storage to a second address indicative of the location of the relay apparatus;
a first location information referring process in which the terminal apparatus refers to the location information in which the first address has been changed to the second address by executing the first changing process;
an accessing process in which the terminal apparatus gains access to the relay apparatus based on the location information which has been referred to by executing the first location information referring process;
a relaying process in which the relay apparatus relays access to the migration source storage in response to access to the relay apparatus by executing the accessing process; and
a migration process in which, when the access has been relayed by executing the access relaying process, the relay apparatus makes the migration data migrate to another storage.

14. The relay method according to claim 13, further comprising:
a second changing process in which, when the migration data has been made to migrate to another storage by executing the migration process, the relay apparatus changes the second address to the first address.

15. The relay method according to claim 13, further comprising:
a registration requesting process in which the terminal apparatus sends the relay apparatus a request that the terminal apparatus be registered;
a registering process in which the relay apparatus registers the terminal apparatus in response to the request that the terminal apparatus be registered by executing the registration requesting process; and
a first requesting process in which the relay apparatus requests the terminal apparatus which has been registered by execution of the registering process to refer to the location information in which the first address has been changed to the second address by executing the first changing process,
wherein the location information in which the first address has been changed to the second address by executing the first changing process is referred to by executing the first location information referring process in response to the request made by executing the first requesting process.

16. The relay method according to claim 15, further comprising:
a second requesting process in which, when the migration data has been made to migrate to another storage by executing the migration process, the relay apparatus sends the terminal apparatus which has been registered by executing the registering process a request that the location information in which the second address has been changed to the first address by executing the second changing process be referred to; and
a second location information referring process in which the terminal apparatus refers to the location information in which the second address has been changed to the first address by executing the second changing process in response to the request made by executing the second requesting process.

17. The relay method according to claim 13, further comprising:
an acquiring process in which the relay apparatus acquires first mount information indicative of whether the terminal apparatus mounts the migration source storage from the migration source storage,
wherein, when the first mount information which has been acquired by executing the acquiring process indicates that the terminal apparatus does not mount the migration source storage, the migration data is made to migrate to another storage by executing the migration process.

18. The relay method according to claim 14, further comprising:
a referring process in which, when the second address has been changed to the first address in the location information by executing the second changing process, the relay apparatus refers to second mount information which is registered in the relay apparatus and indicates whether the terminal apparatus mounts the relay apparatus; and
a stopping process in which, when the second mount information which has been referred to by executing the referring process indicates that the terminal apparatus does not mount the relay apparatus, the relay apparatus stops relaying of the access which has been relayed by executing the relaying process.
